(19) United States
(12) Patent Application Publication
(10) Pub. No.: US 2026/0170145 A1
(43) Pub. Date: Jun. 18, 2026

(54) VEHICLE-MOUNTED APPARATUS, SERVER APPARATUS, STORAGE MEDIUM, AND SECURITY RISK AVOIDANCE METHOD

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventors: Yasuaki SAKAMOTO, Osaka-shi (JP); Akihiro OGAWA, Osaka-shi (JP); Kazuhiro KAKITO, Osaka-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 19/124,106

(22) PCT Filed: Sep. 27, 2023
(86) PCT No.: PCT/JP2023/035059

§ 371 Date: Apr. 24, 2025

(30) Foreign Application Priority Data
Nov. 4, 2022 (JP) 2022-176866

(51) Int. Cl. G06F 21/57; G08G 1/0967; G08G 1/16

(52) U.S. Cl. CPC G06F 21/577; G08G 1/096716; G08G 1/162

(57) ABSTRACT

A vehicle-mounted apparatus configured to be mounted in a vehicle, the vehicle-mounted apparatus including: a processor that is configured to: acquire security reliability level information from an external apparatus, the security reliability level information including information relating to security of a communication terminal located outside the vehicle and information relating to a communication range of the communication terminal; determine whether it is necessary to avoid communication with the communication terminal based on the security reliability level information acquired; and execute predetermined processing using a determination result of whether it is necessary to avoid communication with the communication terminal.

### BACKGROUND

The present disclosure relates to a vehicle-mounted apparatus, a server apparatus, a computer program, and a security risk avoidance method. This application is based upon and claims the benefit of priority of the prior Japanese Patent Application No 2022-176866, filed on 4 Nov. 2022, the entire contents of which are incorporated herein by reference.

Vehicles equipped with vehicle-mounted apparatuses with a communication function for external communication are becoming more common. Such vehicles receive various information from external security countermeasure levels via this communication function. Based on the received information, vehicle-mounted apparatuses may assist the driver in driving safely, for example.

Vehicles communicate with other vehicles via vehicle-to-vehicle communication and with roadside apparatuses via road-to-vehicle communication and thereby acquire various information from other vehicles or roadside apparatuses. A vehicle with an autonomous driving function ensures that the vehicle drives safely using information obtained from other vehicles or roadside apparatuses. On the other hand, equipping a vehicle with a communication function risks the vehicle becoming the target of a cyber attack. The risk to security increases when communication is performed with a vehicle where a security error has occurred due to a cyber attack.

To address this problem, JP 2020-184651A, described later, proposes a technology that enables other vehicles to perform an abnormality avoidance operation when a security abnormality has occurred at a vehicle that belongs to a network.

In more detail, JP 2020-184651A discloses a server apparatus that receives data transmitted from each vehicle that belongs to a network and specifies vehicles where a security abnormality has occurred. When a vehicle belonging to the network has detected that a security abnormality has occurred at that vehicle, the vehicle transmits abnormality information on the detected abnormality to a server apparatus. The transmitted abnormality information includes vehicle identification information for identifying the vehicle where the security abnormality occurred, and location information of the vehicle where the security error occurred.

By receiving the abnormality information, the server apparatus specifies the vehicle where the security abnormality occurred (hereinafter referred to as the “abnormal vehicle”) and notifies other vehicles on the network of the location information of the abnormal vehicle. The other vehicles that have received this notification from the server apparatus take action to avoid the abnormal vehicle based on the indicated location information.

### SUMMARY

A vehicle-mounted apparatus according to an aspect of the present disclosure is a vehicle-mounted apparatus mounted in a vehicle and includes: an acquisition unit configured to acquire security reliability level information from an external apparatus, the security reliability level information including information relating to security of a communication terminal located outside the vehicle and information relating to a communication range of the communication terminal; a determining unit configured to determine whether it is necessary to avoid communication with the communication terminal based on the security reliability level information acquired by the acquisition unit; and a process executing unit configured to execute predetermined processing using a determination result of the determining unit.

A server apparatus according to another aspect of the present disclosure includes: a receiver unit configured to receive predetermined terminal information transmitted from an external communication terminal; a reliability level determining unit configured to determine a security reliability level of the communication terminal based on the terminal information received by the receiver unit; an information generating unit configured to generate security reliability level information including information relating to security of the communication terminal, which includes a determination result of the reliability level determining unit, and information relating to the communication range of the communication terminal and is based on the terminal information; and an information distributing unit configured to distribute the security reliability level information generated by the information generating unit to a vehicle-mounted apparatus.

A computer program according to yet another aspect of the present disclosure is a computer program that causes a computer mounted in a vehicle to function as: an acquisition unit configured to acquire security reliability level information from an external apparatus, the security reliability level information including information relating to security of a communication terminal located outside the vehicle and information relating to a communication range of the communication terminal; a determining unit configured to determine whether it is necessary to avoid communication with the communication terminal based on the security reliability level information acquired by the acquisition unit; and a process executing unit configured to execute predetermined processing using a determination result of the determining unit.

A security risk avoidance method according to yet another aspect of the present disclosure is a security risk avoidance method for a vehicle-mounted apparatus mounted in a vehicle and includes: a step of acquiring security reliability level information from an external apparatus, the security reliability level information including information relating to security of a communication terminal located outside the vehicle and information relating to a communication range of the communication terminal; a step of determining whether it is necessary to avoid communication with the communication terminal based on the security reliability level information acquired by the step of acquiring; and a step of executing predetermined processing using a determination result of the step of determining.

The present disclosure can be realized not only as a vehicle-mounted apparatus, a server apparatus, a computer program, and a security risk avoidance method with the characteristic configurations described above, but also as a recording medium on which a program for causing a computer to execute the characteristic steps executed by the vehicle-mounted apparatus or the server apparatus is recorded. The present disclosure can also be realized as another system or security countermeasure level including a vehicle-mounted apparatus or a server apparatus.

### BRIEF DESCRIPTION OF THE DRAWINGS

FIG. 1 is a diagram useful in explaining the configuration of a system according to a first embodiment.

FIG. 2 is a diagram useful in explaining a vehicle in which the vehicle-mounted apparatus appearing in FIG. 1 is mounted.

FIG. 3 is a diagram useful in explaining a dynamic map.

FIG. 4 is a diagram useful in explaining the configuration of the vehicle-mounted apparatus appearing in FIG. 1.

FIG. 5 is a diagram useful in explaining the configuration of the server apparatus appearing in FIG. 1.

FIG. 6 is a block diagram depicting one example of the hardware configuration of the vehicle-mounted apparatus appearing in FIG. 4.

FIG. 7 is a block diagram depicting one example of the hardware configuration of the server apparatus appearing in FIG. 1.

FIG. 8 is a block diagram depicting one example of the functional configuration of the vehicle-mounted apparatus appearing in FIG. 6.

FIG. 9 is a block diagram depicting one example of the functional configuration of the server apparatus appearing in FIG. 7.

FIG. 10 is a diagram useful in explaining a method of constructing a security reliability level management map.

FIG. 11 is a diagram useful in explaining a method of constructing a security reliability level management map.

FIG. 12 is a diagram useful in explaining a method of constructing a security reliability level management map.

FIG. 13 is a diagram useful in explaining a method of constructing a security reliability level management map.

FIG. 14 is a flowchart depicting one example of a control structure of a program to be executed by a vehicle-mounted apparatus according to the first embodiment.

FIG. 15 is a detailed flowchart of step S1050 in FIG. 14.

FIG. 16 is a diagram useful in explaining the operation of a system when constructing a security reliability level management map.

FIG. 17 is a block diagram depicting one example of the functional configuration of a vehicle mounted apparatus according to a first modification.

FIG. 18 is a flowchart depicting one example of a control structure of a program executed by a vehicle-mounted apparatus according to the second embodiment.

FIG. 19 is a block diagram useful in explaining a vehicle-mounted apparatus according to a third embodiment.

FIG. 20 is a diagram useful in explaining the configuration of a system according to the third embodiment.

FIG. 21 is a flowchart depicting one example of a control structure of a program executed by a vehicle-mounted apparatus according to the third embodiment.

FIG. 22 is a block diagram depicting one example of the functional configuration of a vehicle-mounted apparatus according to a fourth embodiment.

FIG. 23 is a flowchart depicting one example of a control structure of a program executed by the vehicle-mounted apparatus according to the fourth embodiment.

### DETAILED DESCRIPTION OF EMBODIMENTS

### Technical Problem

When avoiding an abnormal vehicle based on location information, there is a risk of a vehicle unintentionally communicating with the abnormal vehicle. When attempting to avoid unintentional communication with an abnormal vehicle, a vehicle may be forced to make a significant detour. This risks a drop in efficiency, such as transportation efficiency.

In addition, in areas in which terminals, including vehicle-mounted apparatuses, with a low security reliability level are present, there is a risk of a security attack that uses such a terminal as a springboard. This means that from the perspective of avoiding the risk of a security attack, it can be insufficient to simply avoid vehicles where a security abnormality has occurred.

The present disclosure was conceived to solve the problems described above and it is an object of the present disclosure to provide a vehicle-mounted apparatus, a server apparatus, a computer program, and a security risk avoidance method capable of avoiding a security risk while suppressing a drop in the efficiency of travel.

### Advantageous Effects of Disclosure

According to the present disclosure, it is possible to provide a vehicle-mounted apparatus, a server apparatus, a computer program, and a security risk avoidance method capable of avoiding a security risk while suppressing a drop in the efficiency of travel.

### Outline of Embodiments of the Present Disclosure

Several embodiments of the present disclosure will first be listed and described in outline. The embodiments described below may be freely combined, at least in part.
(1) A vehicle-mounted apparatus according to a first aspect of the present disclosure is a vehicle-mounted apparatus mounted in a vehicle and includes: an acquisition unit configured to acquire security reliability level information from an external apparatus, the security reliability level information including information relating to security of a communication terminal located outside the vehicle and information relating to a communication range of the communication terminal; a determining unit configured to determine whether it is necessary to avoid communication with the communication terminal based on the security reliability level information acquired by the acquisition unit; and a process executing unit configured to execute predetermined processing using a determination result of the determining unit.

The vehicle-mounted apparatus acquires security reliability level information from an external apparatus, and determines whether it is necessary to avoid communication with a communication terminal based on the acquired security reliability level information. The security reliability level information includes information relating to the communication range of the communication terminal in addition to information relating to the security of the communication terminal. When the determining unit has determined that it is necessary to avoid communication with the communication terminal, the vehicle-mounted apparatus can avoid communication with the communication terminal without making a significant detour by simply avoiding the communication range of the communication terminal while the vehicle is travelling. By doing so, it is possible to avoid a security risk while suppressing a drop in the efficiency of travel by the vehicle.
(2) In (1) above, the process executing unit may include a route proposing unit configured to propose, in keeping with a determination result of the determining unit, a travel route that avoids a communication range of the communication terminal to an occupant of the vehicle. By doing so, the communication range of the communication terminal can be easily avoided while the vehicle is travelling. The vehicle-mounted apparatus can easily avoid communication with the communication terminal without a significant detour being made.
(3) In (1) above, the process executing unit may include a travel route control unit configured to change, in keeping with a determination result of the determining unit, a planned travel route of the vehicle to a travel route that avoids a communication range of the communication terminal. In this way also, the communication range of the communication terminal can be easily avoided while the vehicle is travelling.
(4) In any of (1) to (3) above, the determining unit may determine whether it is necessary to avoid communication with the communication terminal based on whether a reliability level relating to security of the communication terminal is equal to or lower than a certain level and whether the communication range of the communication terminal overlaps a planned driving route of the vehicle. By doing so, it is possible to easily determine whether it is necessary to change the planned driving route of the vehicle.
(5) In any of (1) to (4) above, the security reliability level information may further include information relating to a communication interface of the communication terminal, and the vehicle mounted apparatus may further include a changing unit configured to change, in keeping with the determination result of the determination unit, a communication interface of the vehicle to a communication interface that differs from the communication interface of the communication terminal. By doing so, it is possible to easily avoid communication with a communication terminal with a low security reliability level.
(6) In any of (1) to (3) above, the security reliability level information may further include information relating to a communication interface of the communication terminal, and the determining unit may determine whether it is necessary to avoid communication with the communication terminal based on whether a reliability level relating to security of the communication terminal is equal to or lower than a certain level, whether the communication range of the communication terminal overlaps a planned travel route of the vehicle, and whether a communication interface that is the same as the communication interface of the communication terminal is being used at the vehicle. By doing so, it is possible to more easily avoid a security risk while suppressing a drop in the efficiency of travel by the vehicle.
(7) In any of (1) to (6) above, the vehicle-mounted apparatus may further include an information display unit configured to display, based on the security reliability level information, map information, in which areas where avoidance of travel is recommended are indicated, on a display apparatus installed inside the vehicle. By doing so, it is possible to present areas where it is better to avoid travelling to the occupants (driver) of a vehicle. This makes it easier to avoid communication with communication terminals with a low security reliability level.
(8) A server apparatus according to a second aspect of the present disclosure includes: a receiver unit configured to receive predetermined terminal information transmitted from an external communication terminal; a reliability level determining unit configured to determine a security reliability level of the communication terminal based on the terminal information received by the receiver unit; an information generating unit configured to generate security reliability level information including information relating to security of the communication terminal, which includes a determination result of the reliability level determining unit, and information which relates to a communication range of the communication terminal and is based on the terminal information; and an information distributing unit configured to distribute the security reliability level information generated by the information generating unit to a vehicle-mounted apparatus.

The server apparatus determines the security reliability level of the communication terminal based on the terminal information transmitted from the communication terminal, and generates security reliability level information. The server apparatus distributes the generated security reliability level information to vehicle-mounted apparatuses. By distributing the security level reliability information to the vehicle mounted apparatuses, the server apparatus can enable vehicle-mounted apparatuses to determine whether it is necessary to avoid communication with the communication terminal. In keeping with the determination result of a vehicle mounted apparatus, a vehicle equipped with the vehicle-mounted apparatus can avoid communication with the communication terminal without making a significant detour by simply avoiding the communication range of the communication terminal. In this way, the server apparatus can enable a vehicle equipped with a vehicle-mounted apparatus to travel in a manner that avoids a security risk while suppressing a drop in the efficiency of travel.
(9) In (8) above, the terminal information received by the receiver unit may include location information of the communication terminal, information relating to security countermeasures at the communication terminal, information relating to security abnormalities at the communication terminal, and a radio wave transmission range of the communication terminal, the reliability level determining unit may determine the security reliability level of the communication terminal based on the information relating to security countermeasures at the communication terminal and the information relating to security abnormalities at the communication terminal, and the information generating unit may set the communication range taking into consideration radio wave obstructions in a periphery of the communication terminal based on the location information of the communication terminal and the radio wave transmission range of the communication terminal. By doing so, it is possible to increase the determination accuracy of the security reliability level of the communication terminal and the accuracy of the communication range of the communication terminal.
(10) In (8) or (9) above, the security reliability level information may include a security reliability level management map in which information relating to security of the communication terminal and information relating to the communication range of the communication terminal are added to a map of a management area managed by the server apparatus, and the information generating unit may generate the security reliability level management map based on the information relating to the security of the communication terminal and the terminal information. By distributing a security reliability management map to vehicle-mounted apparatuses, it becomes easy for vehicles equipped with the vehicle-mounted apparatuses to avoid security risks while suppressing a drop in the efficiency of travel.
(11) In (10) above, the information distributing unit may distribute the security reliability level management map generated by the information generating unit to a vehicle-mounted apparatus located in the management area. By doing so, it is easy to distribute a security reliability level management map for an area required by vehicle-mounted apparatuses to such vehicle-mounted apparatuses.
(12) A computer program according to a third aspect of the present disclosure causes a computer mounted in a vehicle to function as: an acquisition unit configured to acquire security reliability level information from an external apparatus, the security reliability level information including information relating to security of a communication terminal located outside the vehicle and information relating to a communication range of the communication terminal; a determining unit configured to determine whether it is necessary to avoid communication with the communication terminal based on the security reliability level information acquired by the acquisition unit; and a process executing unit configured to execute predetermined processing using a determination result of the determining unit.
(13) A security risk avoidance method according to a fourth aspect of the present disclosure is a security risk avoidance method for a vehicle-mounted apparatus mounted in a vehicle and includes: a step of acquiring security reliability level information from an external apparatus, the security reliability level information including information relating to security of a communication terminal located outside the vehicle and information relating to a communication range of the communication terminal; a step of determining whether it is necessary to avoid communication with the communication terminal based on the security reliability level information acquired by the step of acquiring; and a step of executing predetermined processing using a determination result of the step of determining.

### Detailed Description of Embodiments of Present Disclosure

Specific embodiments of a vehicle-mounted apparatus, a server apparatus, a computer program, and a security risk avoidance method according to embodiments of the present disclosure are described below with reference to the accompanying drawings. Note that in the following embodiments, parts that are identical have been assigned the same reference numerals. Such parts have the same functions and names. For this reason, detailed description of such parts is not repeated.

### First Embodiment

### Overall Configuration

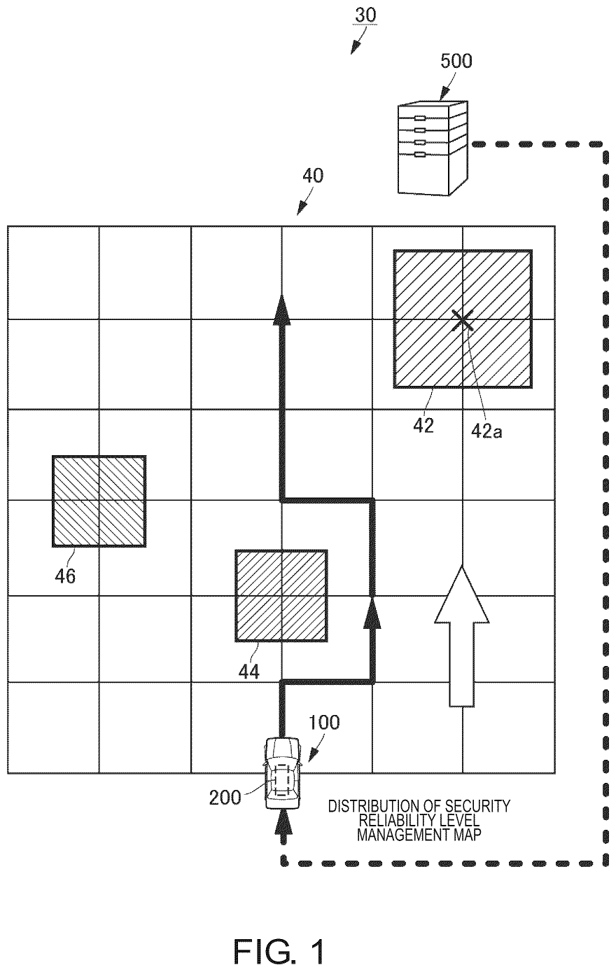

As depicted in FIG. 1, the system 30 according to the present embodiment includes a vehicle-mounted apparatus 200 mounted in a vehicle 100 and a server apparatus 500 that communicates with the vehicle-mounted apparatus 200. The server apparatus 500 is an external apparatus that is set up outside the vehicle. The server apparatus 500 may be a cloud server or may be an edge server. The number of vehicles (or vehicle-mounted apparatuses) that communicate with the server apparatus 500 is not limited to one, and may a plurality of vehicles and/or apparatuses.

The vehicle 100 (hereinafter “host vehicle”) in which the vehicle-mounted apparatus 200 is mounted has a function of performing wireless communication not only with the server apparatus 500 but also with various communication terminals located outside the host vehicle 100. These communication terminals include vehicle-mounted apparatuses (or “vehicle-mounted terminals”) mounted in vehicles aside from the host vehicle 100, roadside security countermeasure levels (or “roadside apparatuses”) installed at the roadside, and mobile terminals (such as smartphones) carried by pedestrians or vehicle occupants. In other words, the vehicle 100 has a short-range communication function, such as vehicle-to-vehicle communication and road-to-vehicle communication, in addition to a wide-area communication function. Note that the expression “communication terminals” may include domestic appliances with a function of connecting to a network.

When the vehicle 100 is travelling in a certain area, the vehicle 100 may communicate with various communication terminals. Such terminals include communication terminals with a high security reliability level and other terminals with a low security reliability level. Communication terminals with a low security reliability level are at risk of being used as a springboard for security attacks. For this reason, in an area in which communication terminals with a low security reliability level are present, communicating with such communication terminals increases the risk of a security attack that uses such communication terminals as a springboard.

In the system 30 according to the present embodiment, to reduce the risk of a security attack, the server apparatus 500 provides the vehicle-mounted apparatus 200 with information relating to communication terminals with a low security reliability level. The server apparatus 500 distributes a security reliability level management map 40, which will be described later, to the vehicle-mounted apparatus 200. The security reliability level management map 40 indicates threat terminal areas 42, 44, and 46. The security reliability level management map 40 may also indicate the location 42a of a threat terminal.

A threat terminal area is an area in which a communication terminal (hereinafter, sometimes referred to as a “threat terminal”) whose security reliability level is equal to or lower than a predetermined value is present and is defined by the communication range of that threat terminal. When the vehicle 100 enters a threat terminal area, the risk of the vehicle-mounted apparatus 200 communicating with a threat terminal increases.

When the vehicle-mounted apparatus 200 receives the security reliability level management map 40 distributed from the server apparatus 500, the vehicle-mounted apparatus 200 determines whether it is necessary to avoid communication with communication terminals based on the received security reliability level management map 40. As one example, the vehicle-mounted apparatus 200 determines whether a threat terminal area is present on a planned travel route of the vehicle 100. When a threat terminal area is present on the planned travel route, the vehicle-mounted apparatus 200 executes a predetermined process to change the route so as to bypass the threat terminal area.

### Configuration of Vehicle-Mounted Apparatus 200

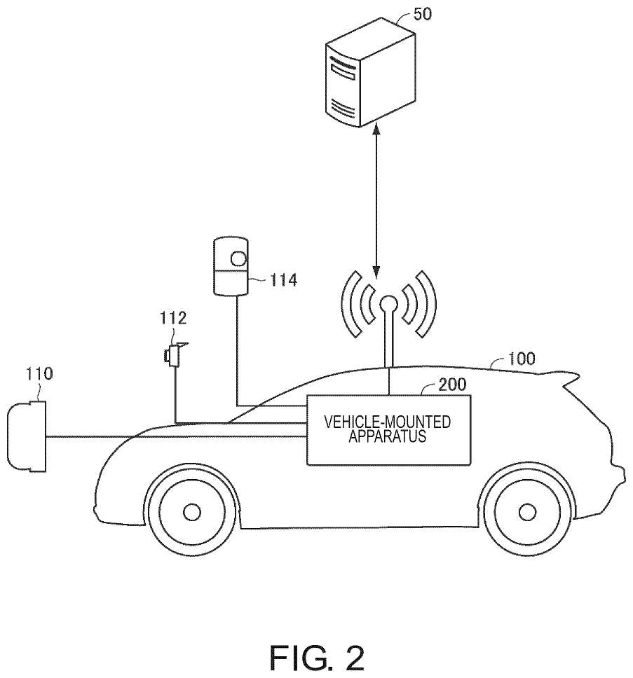

As depicted in FIG. 2, the vehicle-mounted apparatus 200 can also communicate with a server apparatus (or “infrastructure apparatus 50”) aside from the server apparatus 500 that constructs the present system 30. The vehicle 100 in which the vehicle-mounted apparatus 200 is mounted is equipped with various sensors, such as a millimeter-wave radar 110, a vehicle-mounted camera 112, and a LiDAR (Laser Imaging Detection and Ranging) 114, in addition to the vehicle-mounted apparatus 200. As one example, the vehicle-mounted apparatus 200 may collect sensor data from such sensors and wirelessly transmit the data to the infrastructure apparatus 50, and may also receive various information including a dynamic map from the infrastructure apparatus 50.

The infrastructure apparatus 50 receives sensor data transmitted from vehicle-mounted sensors mounted in vehicles, a roadside sensor mounted on a roadside security countermeasure level, and the like, and generates a dynamic map to be used for purposes such as assisting driving safety. The infrastructure apparatus 50 distributes the generated dynamic map to the vehicles.

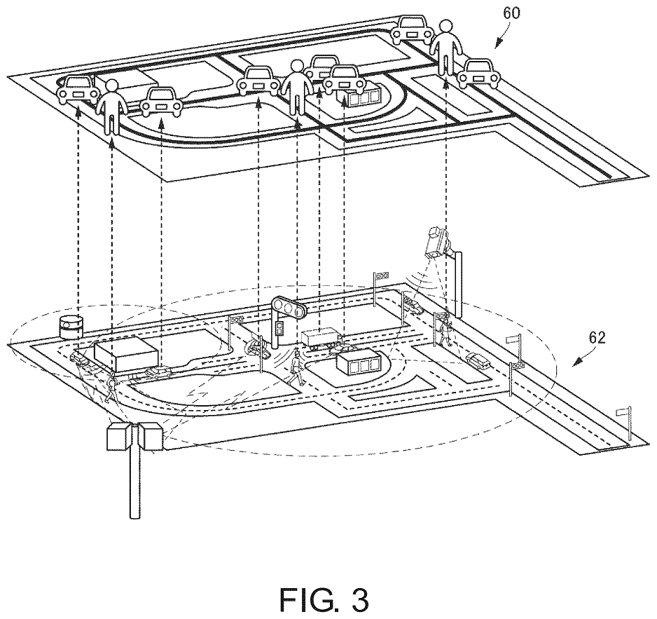

As depicted in FIG. 3, the dynamic map 60 is generated using high-resolution road map data, which has been prepared in advance in a virtual space, by detecting moving objects in a real space 62 using multiple sensors such as LiDAR and cameras and estimating attributes (such as “adult”, “child”, “vehicle”, and “motorcycle”) of such objects. The dynamic map 60 includes dynamic information such as information on surrounding vehicles and pedestrians, semi-dynamic information such as accident information and congestion information, semi-static information such as traffic regulations or information on scheduled road maintenance, and static information such as road surface information and lane information (high-precision three-dimensional map information).

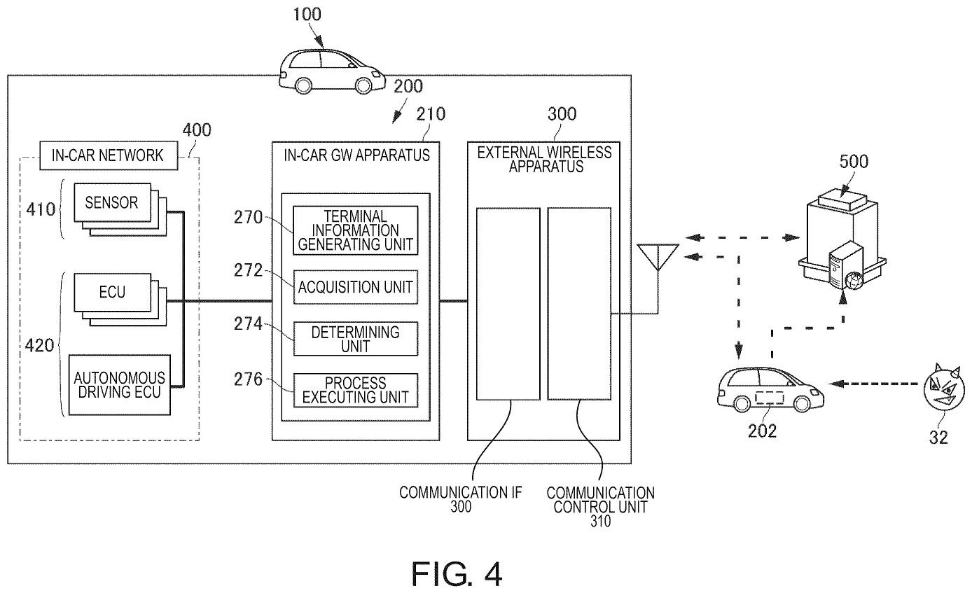

As depicted in FIG. 4, the vehicle-mounted apparatus 200 includes an in-car gateway (GW) apparatus (hereinafter, simply referred to as a “GW apparatus”) 210. In addition to the GW apparatus 210, the vehicle 100 is equipped with an external wireless apparatus 300 and an in-car network 400, which is a communication network including various sensors and various ECUs (Electronic Control Units). A vehicle is typically equipped with a plurality of in-car networks. In FIG. 4, an in-car network 400 is illustrated to represent a plurality of in-car networks and other in-car networks have been omitted.

The GW apparatus 210 interconnects the plurality of in-car networks including the in-car network 400 and manages data exchanges between the in-car networks. The in-car network 400 includes a sensor group 410 including various sensors and an ECU group 420 including various ECUs. If the vehicle 100 has an autonomous driving function, the ECU group 420 includes an autonomous driving ECU.

The GW apparatus 210 further includes, as functional units, a terminal information generating unit 270, an acquisition unit 272, a determining unit 274, and a process executing unit 276. The terminal information generating unit 270 generates terminal information required for the server apparatus 500 to build a security reliability level management map. The terminal information generated by the terminal information generating unit 270 includes, for example, the terminal type, the location (location information) of the host vehicle 100, the movement speed (traveling speed) of the host vehicle 100, a security countermeasure level set for the vehicle-mounted apparatus 200, the current state of the vehicle-mounted apparatus 200, a communication interface currently in use (hereinafter, “interface” is abbreviated to “IF”), and the communication range (such as the radio wave transmission range). The vehicle-mounted apparatus 200 transmits the terminal information generated by the terminal information generating unit 270 via the external wireless apparatus 300 to the server apparatus 500.

The acquisition unit 272 acquires a security reliability level management map from the server apparatus 500. The determining unit 274 determines whether it is necessary to change a planned travel route based on the security reliability level management map acquired by the acquisition unit 272. The process executing unit 276 executes a predetermined process for changing the route according to the determination result of the determining unit 274.

The external wireless apparatus 300 includes a communication IF 310 that performs wireless communication with security countermeasure levels outside the vehicle, and a communication control unit 320 that controls the communication IF 310. The communication IF 310 includes a plurality of wireless IFs (communication IFs). As examples, the plurality of wireless IFs include a wireless IF for performing cellular communication with an external apparatus (exterior apparatus) using 5G (fifth generation mobile communication system) or LTE (Long Term Evolution), and a wireless IF for performing wireless communication with an external apparatus by DSRC (Dedicated Short Range Communication) or C-V2X (Cellular Vehicle to Everything). The wireless IF included in the external wireless apparatus 300 are not limited to these examples and may be another type. As further examples, the external wireless apparatus 300 may be configured to include wireless IFs such as local 5G, Wi-Fi, or Bluetooth (registered trademark). Note that the number of wireless IFs included in the external wireless apparatus 300 is not limited to the example number here.

Various wireless IFs are available corresponding to different communication methods. Among communication methods, cellular communication (4G (LTE)/5G) and LPWA (Low Power Wide Area) are known as wide-area communication, and DSRC and C-V2X are known as narrow range communication. Wi-Fi and local 5G are also known as methods of local communication between wide and narrow areas. Local 5G differs from cellular 5G in that it is independently operated by companies or local governments who are not telecommunications operators.

### Configuration of the Server Apparatus 500

The server apparatus 500 collects information on a threat terminal 202 with a low security reliability level that may be used by an attacker 32 as a springboard for a security attack, and distributes this information as a security reliability level management map.

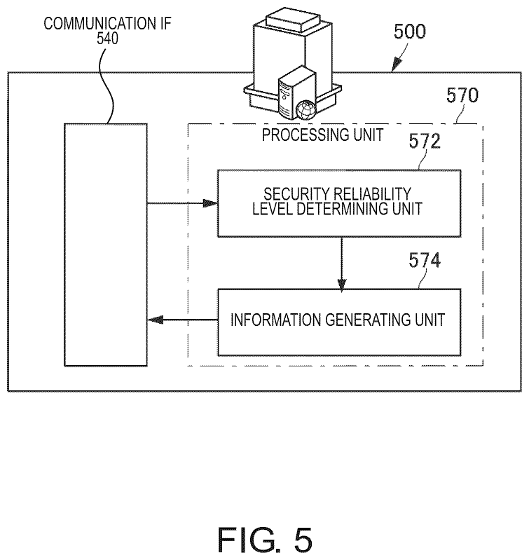

As depicted in FIG. 5, the server apparatus 500 includes a communication IF 540 and a processing unit 570. The processing unit 570 includes a security reliability level determining unit 572 and an information generating unit 574 as functional units. The security reliability level determining unit 572 analyzes terminal information transmitted from communication terminals and determines the security reliability level of each communication terminal. The information generating unit 574 generates security reliability level information to be provided to vehicle-mounted apparatuses using the security reliability levels determined by the security reliability level determining unit 572. In the present embodiment, the information generating unit 574 generates a security reliability level management map as the security reliability level information.

### Hardware Configuration

### GW Apparatus 210

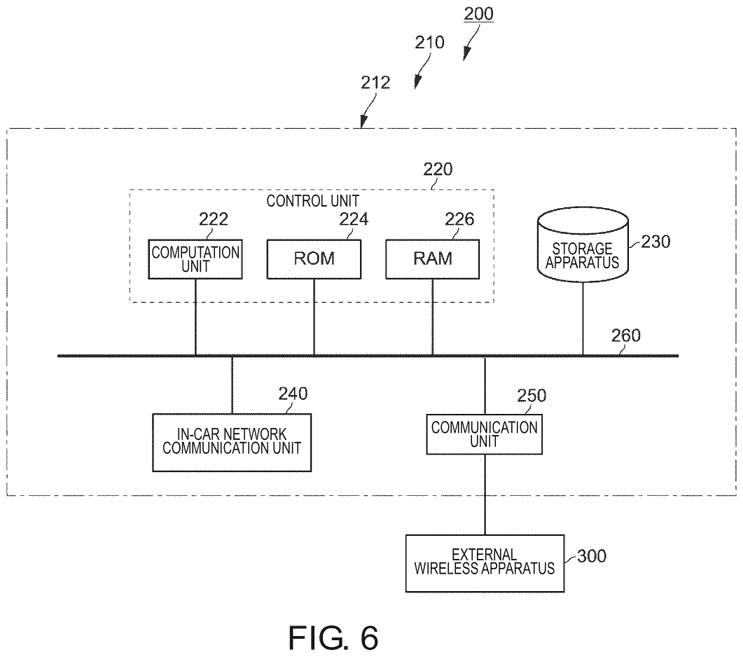

As depicted in FIG. 6, the GW apparatus 210 mounted in the vehicle 100 includes a computer 212. The computer 212 includes a control unit 220 that controls the entire GW apparatus 210, a storage apparatus 230 that stores various data, an in-car network communication unit 240 that communicates with an in-car network, and a communication unit 250 that communicates with the external wireless apparatus 300. The control unit 220, the storage apparatus 230, the in-car network communication unit 240, and the communication unit 250 are all connected to a bus 260 and exchange data via the bus 260.

The control unit 220 includes a computation unit 222, a ROM (Read Only Memory) 224 that stores a boot-up program and the like of the computer 212, and a RAM (Random Access Memory) 226 that can be written and read at any time. As examples of a computational element (or “processor”), the computation unit 222 includes a CPU (Central Processing Unit) or an MPU (Micro Processing Unit). As one example, the storage apparatus 230 includes non-volatile memory, such as flash memory. The ROM 224 or the storage apparatus 230 stores software (computer programs) to be executed by the computation unit 222 and various information (data).

A computer program for causing the GW apparatus 210 to function as the functional units of the GW apparatus 210 according to the present disclosure is distributed having been stored on a predetermined storage medium, such as a DVD (Digital Versatile Disc) or a USB (Universal Serial Bus) memory, and is further transferred from such medium to the storage apparatus 230. Alternatively, the computer program may be transmitted by wireless communication outside the vehicle from an external apparatus to the computer 212 and stored in the storage apparatus 230.

The functions of the functional units of the GW apparatus 210 are realized by software processing executed by the control unit 220 using hardware. Some or all of these functions may be realized by an integrated circuit including a microcomputer.

The in-car network communication unit 240 provides an IF for communicating with an in-car network. The in-car network communication unit 240 communicates with the in-car network according to a communication protocol such as CAN (Controller Area Network). A plurality of in-car network communication units 240 are provided corresponding to a plurality of in-car networks. Under the control of the control unit 220, the GW apparatus 210 (the computer 212) relays data between the in-car networks by transmitting data (messages) received by one in-car network communication unit from another in-car network communication unit. The communication unit 250 provides an IF for communicating with the external wireless apparatus 300.

### Server Apparatus 500

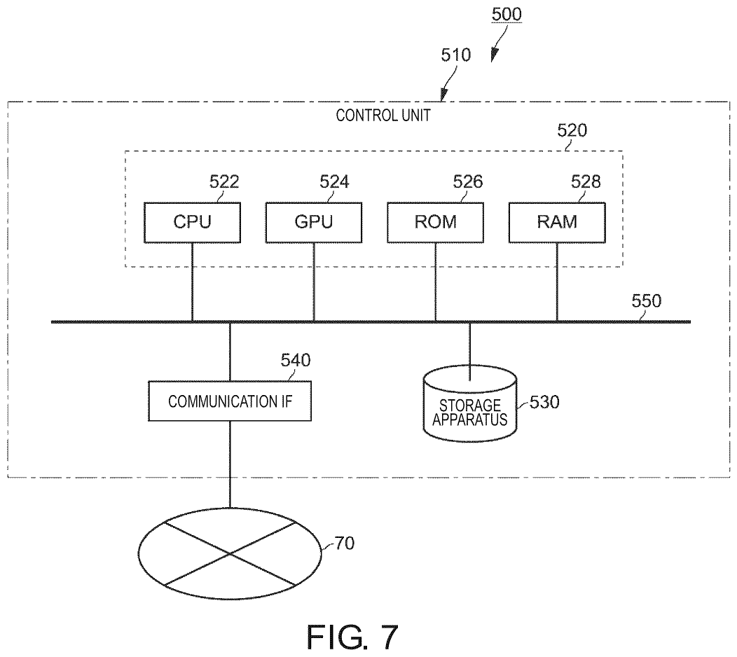

As depicted in FIG. 7, the server apparatus 500 includes a computer 510. The computer 510 includes a control unit 520, a storage apparatus 530, and a communication IF 540. The control unit 520 includes a CPU 522, a GPU (Graphics Processing Unit) 524, a ROM 526, and a RAM 528. The control unit 520, the storage apparatus 530, and the communication IF 540 are all connected to a bus 550 and exchange data with one another via the bus 550.

The storage apparatus 530 includes a non-volatile storage apparatus such as flash memory or a hard disk drive. The storage apparatus 530 stores various information and computer programs to be executed by the CPU 522. The communication IF 540 provides a connection to a network 70 to enable communication with other terminals.

The server apparatus 500 acquires, via the network 70, terminal information for generating or updating a security reliability level management map from the communication terminals. The server apparatus 500 processes the acquired terminal information to generate or update a security reliability level management map. The server apparatus 500 distributes the generated security reliability level management map to vehicles via the network 70.

A computer program for causing the server apparatus 500 to function as the functional units of the server apparatus 500 according to the present embodiment is distributed having been stored on a predetermined storage medium, such as a DVD or a USB memory, and is further transferred from such medium into the storage apparatus 530. Alternatively, the computer program may be transmitted via the network 70 to the computer 510 from an external apparatus and stored in the storage apparatus 530.

### Functional Configuration

### GW Apparatus 210

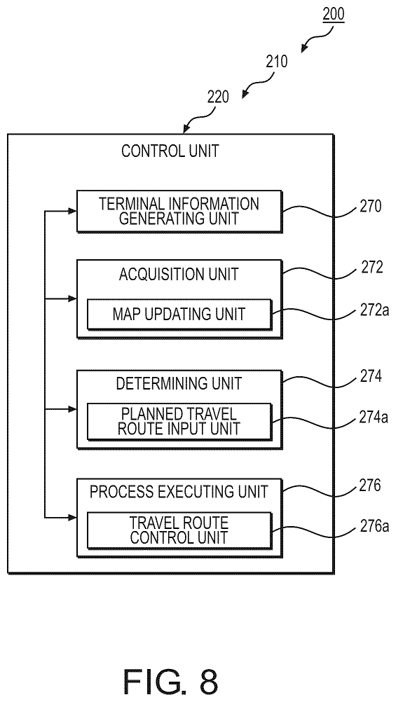

As depicted in FIG. 8 and described above, the control unit 220 of the GW apparatus 210 includes, as functional units, a terminal information generating unit 270, an acquisition unit 272, a determining unit 274, and a process executing unit 276. The acquisition unit 272 includes a map updating unit 272a. When the acquisition unit 272 has acquired an updated security reliability level management map, the map updating unit 272a updates the security reliability level management map to a new security reliability level management map. The determining unit 274 includes a planned travel route input unit 274a. The planned travel route input unit 274a inputs a planned travel route that was set at a car navigation apparatus (not illustrated) installed in the vehicle 100 into the GW apparatus 210. The process executing unit 276 includes a travel route control unit 276a. As one example, the travel route control unit 276a outputs an instruction to the car navigation apparatus to change the travel route. When the vehicle 100 in which the GW apparatus 210 is installed has an autonomous driving function, the travel route control unit 276a performs route control to change the travel route for the autonomous driving ECU, for example.

The functions described here are realized by software processing executed by the control unit 220 using hardware. Some or all of these functions may be realized by an integrated circuit including a microcomputer.

### Server Apparatus 500

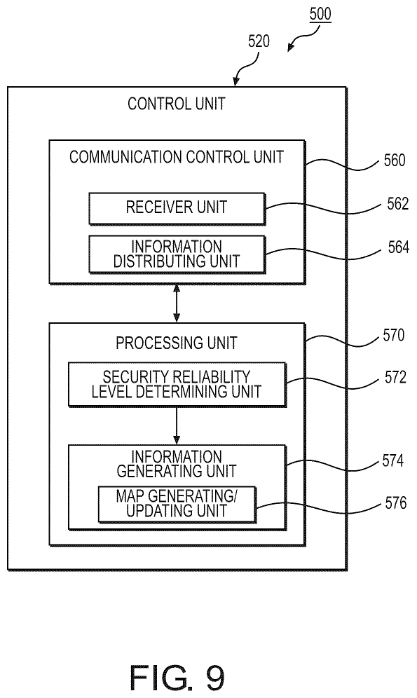

As depicted in FIG. 9, the control unit 520 of the server apparatus 500 includes, as functional units, a communication control unit 560 and the processing unit 570 described above. The communication control unit 560 controls the communication IF 540 (see FIG. 5) to perform communication with the outside. The communication control unit 560 includes a receiver unit 562 (receiver) and an information distributing unit 564. The receiver unit 562 receives, via the communication IF 540, terminal information transmitted from an external communication terminal and outputs the received terminal information to the processing unit 570. The information distributing unit 564 distributes the security reliability level management map generated by the server apparatus 500 via the communication IF 540 to the vehicle-mounted apparatus 200.

As described above, the processing unit 570 includes the security reliability level determining unit 572 and the information generating unit 574. The information generating unit 574 includes a map generating/updating unit 576. The map generating/updating unit 576 uses security reliability levels determined by the security reliability level determining unit 572 to generate or update a security reliability level management map.

These functions are realized by software processing executed by the control unit 520 using hardware. Some or all of these functions may be realized by an integrated circuit including a microcomputer.

### Constructing a Security Reliability Level Management Map

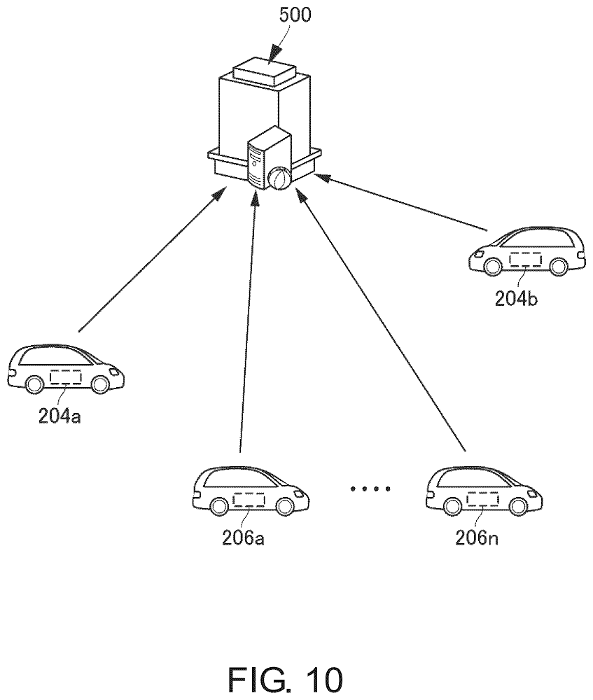

A method for constructing a security reliability level management map at the server apparatus 500 will now be described with reference to FIGS. 10 to 13.

As depicted in FIG. 10, the server apparatus 500 receives predetermined terminal information transmitted from one or a plurality of communication terminals. FIG. 10 depicts an example on which vehicle-mounted apparatuses mounted in vehicles are used as examples of communication terminals. FIG. 10 depicts an example where the server apparatus 500 receives terminal information from a plurality of vehicle-mounted apparatuses 204a, 204b, and 206a, . . . , 206n mounted in a plurality of vehicles. Each of the vehicle-mounted apparatuses 204a, 204b, 206a, . . . , 206n includes a functional unit that is similar to the terminal information generating unit 270 depicted in FIG. 4 and transmits terminal information generated by that functional unit to the server apparatus 500. Note that the communication terminals may be terminal security countermeasure levels aside from a vehicle-mounted apparatus, such as a roadside security countermeasure level (or roadside apparatus), a mobile terminal, or a domestic appliance equipped with a communication function. The communication terminals that are not vehicle-mounted apparatuses may also be configured to transmit the same terminal information as a vehicle-mounted apparatus to the server apparatus 500.

As described above, the terminal information includes various information such as the type of communication terminal, location information, moving speed, a security countermeasure level of the communication terminal, the current state of the communication terminal, the communication IFs in use, and the communication range. Note that the moving speed may be included in the terminal information, but does not need to be included. When a communication terminal is a fixed terminal, such as a roadside security countermeasure level, the communication terminal will not move and the terminal information does not need to include information relating to the moving speed.

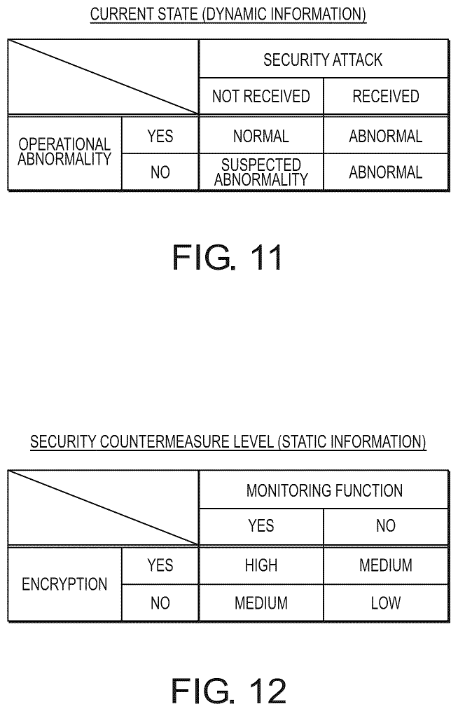

It is assumed that the current state of a communication terminal is classified into three levels: “normal”, “suspected abnormality”, and “abnormal”. The current state is determined based on whether the communication terminal is under a security attack and whether there is an operational abnormality. In more detail, the conversion table depicted in FIG. 11 is stored in a storage apparatus (for example, the storage apparatus 230 (see FIG. 6)) of the communication terminal, and the current state of the communication terminal is determined based on this conversion table. Since the current state of the communication terminal changes over time, this state is also referred to as “dynamic information”.

As depicted in FIG. 11, if the terminal is presently not under a security attack and there is no operational abnormality, the communication terminal determines that the current state is “normal.” If the terminal is not under a security attack but there is an operational abnormality, the communication terminal determines that the current state is “suspected abnormality”. When the terminal is under a security attack, the communication terminal determines the current state is “abnormal” regardless of whether there is an operational abnormality.

It is assumed that the security countermeasure level of a communication terminal is classified into three levels: “high”, “medium” and “low”. The security countermeasure level is determined based on the presence of functions that security countermeasures at the communication terminal. In this example, it is assumed that the security countermeasures in question are encryption and monitoring functions. In more detail, the conversion table depicted in FIG. 12 is stored in a storage apparatus of the communication terminal (for example, the storage apparatus 230 (see FIG. 6)), and the security countermeasure level of the communication terminal is determined based on this conversion table. The security countermeasure level may be determined based on the provision of existing detection technologies (as examples, a firewall and an abnormality detection filter) or the update status, or the security countermeasure level may be determined based on the version of the OS (Operating System), the most recent updating date of the OS, or the like.

As depicted in FIG. 12, if a communication terminal includes both encryption and monitoring functions, the security countermeasure level is “high.” If a communication terminal includes one of the encryption and monitoring functions, the security countermeasure level is “medium”. If a communication terminal does not have either an encryption or a monitoring function, the security countermeasure level is “low”. Since the security countermeasure level of a communication terminal is set in advance, the security countermeasure level is also referred to as “static information”. Since the security countermeasure level does not change dynamically, one of “high,” “medium,” or “low” may be set in advance as the security countermeasure level instead of the security countermeasure level being determined using a conversion table. In this case, there is no need to store the conversion table depicted in FIG. 12 in a storage apparatus of a communication terminal.

When the server apparatus 500 has received the terminal information transmitted from a communication terminal, the server apparatus 500 determines the security reliability level of the communication terminal using information on the current state of the communication terminal and the security countermeasure level of the communication terminal, which are included in the terminal information. The security countermeasure level is classified into three levels, namely “high”, “medium”, and “low”.

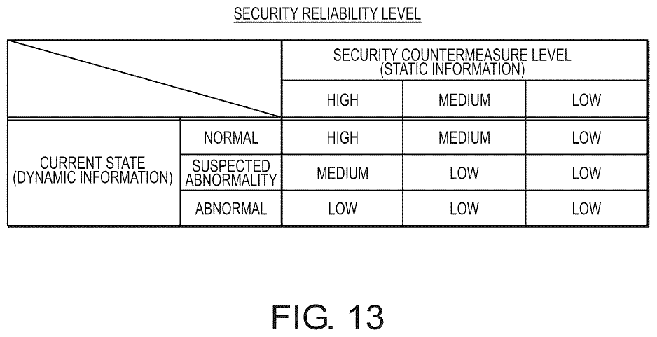

The storage apparatus 530 (see FIG. 7) of the server apparatus 500 stores the determination table depicted in FIG. 13. The server apparatus 500 refers to this determination table and determines the security reliability level of a communication terminal from the current state of that communication terminal and the security countermeasure level of that communication terminal.

As depicted in FIG. 13, the determination rules of the determination table use the value of the security countermeasure level as is when the current state is “normal”. When the current state is “abnormality suspected”, the value of the security countermeasure level is lowered by one level compared to the “normal” case. When the current state is “abnormal”, the security reliability level is set to “low” regardless of the value of the security countermeasure level. The determination rules of the determination table depicted in FIG. 13 are mere examples, and may be changed as appropriate.

The server apparatus 500 generates (updates) the security reliability level management map using the received terminal information and the determination result of the security reliability level. In more detail, the server apparatus 500 performs area management in keeping with the communication range, and generates a security reliability level management map in which the location information, communication range, security reliability level (that is, the determination result), and the like of each communication terminal are added to a map of the management area managed by the present server apparatus 500.

In the present embodiment, a communication terminal for which a determination result of “medium” or “low” has been produced for the security reliability level is defined as a “threat terminal.” The security reliability level management map indicates the location information of a threat terminal and a threat terminal area that indicates the communication range of that threat terminal. In addition to the threat terminal areas, the security reliability level management map may be configured to display information on communication terminals for which a determination result of “high” has been produced for the security reliability level.

The communication range of a communication terminal in the security reliability level management map may be displayed using the communication range included in the terminal information. On the security reliability level management map, the server apparatus 500 may further display a communication range that takes into account radio wave obstructions in the periphery of a communication terminal, based on the map of the management area, the location information of the communication terminal, and the communication range included in the terminal information.

The server apparatus 500 distributes the generated or updated security reliability level management map on a regular or irregular basis to vehicle-mounted apparatuses located in the management area. As one example, the server apparatus 500 distributes the security reliability level management map to vehicle-mounted apparatuses located in the management area by broadcasting. As one example, the server apparatus 500 may update the security reliability level management map on a predetermined cycle and distribute the updated security reliability level management map.

### Software Configuration

### Vehicle-Mounted Apparatus 200

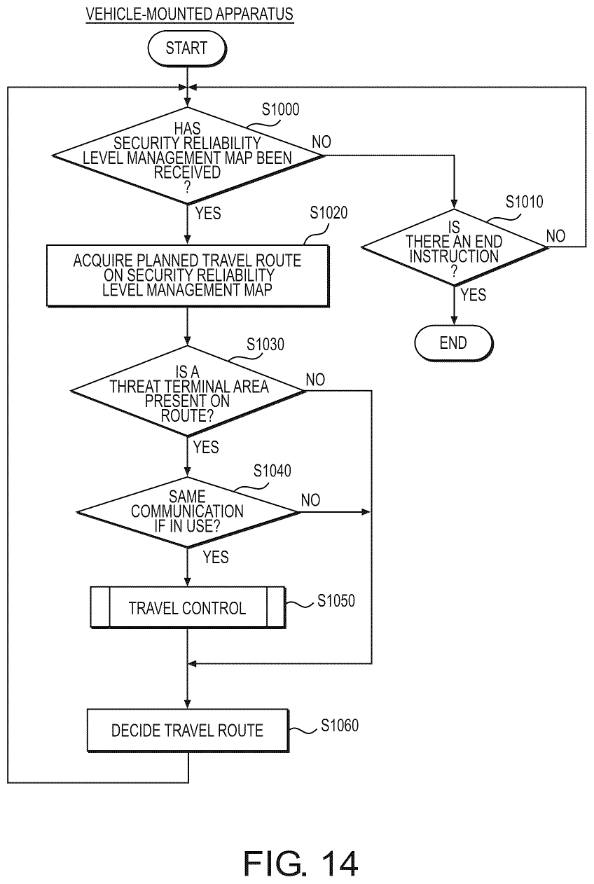

The control structure of a computer program that is executed at a vehicle-mounted apparatus 200 to avoid security risks while suppressing a drop in the efficiency of travel will now be described with reference to FIG. 14. As one example, this program starts when the vehicle 100 in which the vehicle-mounted apparatus 200 is mounted has been placed in a drivable state.

This program includes step S1000, which determines whether a security reliability level management map has been received and branches the control flow in keeping with the determination result, and step S1010, which is executed when it has been determined in step S1000 that a security reliability level management map has not been received, which determines whether an end instruction has been given, and branches the control flow depending on the determination result. As one example, the end instruction includes the vehicle 100 stopping and being placed in a state where the power source is off. If it has been determined in step S1010 that an end instruction has been given, the program ends. If it has been determined in step S1010 that an end instruction has not been given, the control returns to step S1000. That is, the vehicle-mounted apparatus 200 waits until a security reliability level management map is received or until an end instruction has been issued.

The program further includes, as steps executed when it has been determined in step S1000 that a security reliability level management map has been received, step S1020 that acquires a planned travel route on the security reliability level management map, step S1030 that is executed after step S1020, determines whether a threat terminal area is present on the planned travel route, and branches the flow of control in keeping with the determination result, a step S1040 that is executed when it has been determined in step S1030 that a threat terminal area is present on the planned travel route, determines whether the vehicle 100 (that is, the host vehicle) in which the vehicle-mounted apparatus 200 is mounted is using the same communication IF (wireless IF) as the threat terminal located in the threat terminal area, and branches the flow of control according to this determination result, and a step S1050 that is executed when it has been determined in step S1040 that the same communication IF as the threat terminal is being used and controls the driving of the vehicle 100.

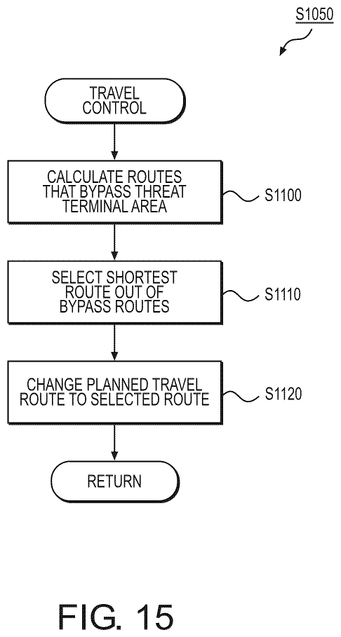

FIG. 15 is a detailed flowchart of step S1050 in FIG. 14. As depicted in FIG. 15, this routine includes step S1100 for calculating routes that bypass the threat terminal area, step S1110 which is executed after step S1100 and selects the shortest route out of the bypass routes, and step S1120 which is executed after step S1110 and changes the planned travel route to the selected route before ending this routine.

As depicted in FIG. 14, the program further includes step S1060, which is executed when it has been determined in step S1030 that there is no threat terminal area on the planned travel route, when it has been determined in step S1040 that the same communication IF as the threat terminal is not in use, or after step S1050, to determine the travel route and return the control to step S1000.

### Operation

The system 30 according to the present embodiment operates as follows.

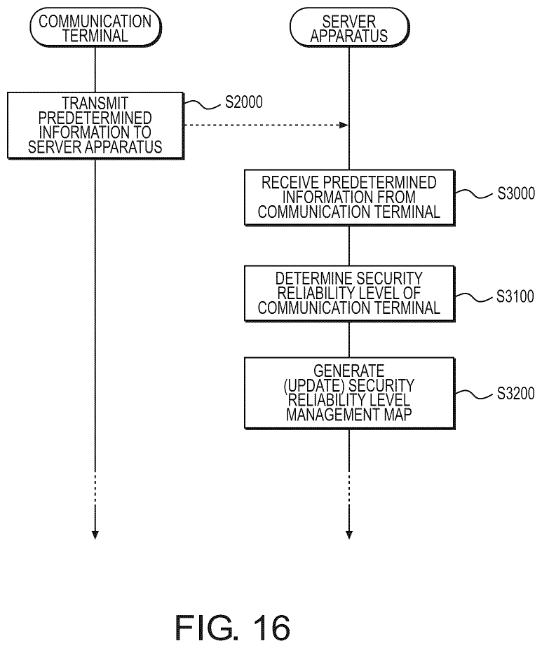

As depicted in FIG. 16, a communication terminal transmits predetermined information (or “terminal information”) to the server apparatus 500 (step S2000). The server apparatus 500 receives the information transmitted from the communication terminal (step S3000). The server apparatus 500 uses the received terminal information to determine the security reliability level of the communication terminal (step S3100). The server apparatus 500 generates (or updates) the security reliability level information (or “security reliability level management map”) using the received terminal information and the determination result of the security reliability level (step S3200). The server apparatus 500 distributes the generated or updated security reliability level management map to vehicle-mounted apparatuses.

As depicted in FIG. 1, for the vehicle 100 equipped with the vehicle-mounted apparatus 200, the planned travel route of the vehicle 100 has been set in a car navigation apparatus. When the vehicle 100 enters an area managed by the server apparatus 500, the vehicle-mounted apparatus 200 receives the security reliability level management map 40 distributed by the server apparatus 500 (YES in step S1000 of FIG. 14). The vehicle-mounted apparatus 200 acquires the planned travel route on the security reliability level management map 40 (step S1020), and determines whether a threat terminal area 42, 44, or 46 is present on the planned travel route. If a threat terminal area 42, 44, or 46 is not present on the planned travel route, the planned travel route that has been set is determined as the travel route without changing the planned travel route (step S1060).

On the other hand, if a threat terminal area 42, 44, or 46 is present on the planned travel route (YES in step S1030), the vehicle-mounted apparatus 200 determines whether the host vehicle is using the same communication IF (wireless IF) as the threat terminal located in that threat terminal area. If the vehicle is not using the same communication IF as the threat terminal (NO in step S1040), the vehicle will not communicate with that threat terminal and therefore the vehicle-mounted apparatus 200 does not execute processing to change the planned travel route.

On the other hand, if the host vehicle is using the same communication IF as a threat terminal (YES in step S1040), there is a risk of the vehicle-mounted apparatus 200 communicating with the threat terminal when the vehicle 100 enters a threat terminal area. In this case, the vehicle-mounted apparatus 200 executes a process to change the travel route to avoid communication with the threat terminal. In more detail, the vehicle-mounted apparatus 200 first calculates routes that bypass the threat terminal area (step S1100 of FIG. 15). After this, the vehicle-mounted apparatus 200 selects the shortest route out of the bypass routes (step S1110) and changes the planned travel route to the selected route (step S1120). As one example, the vehicle-mounted apparatus 200 issues an instruction to the car navigation apparatus to change the planned travel route to the selected route. If the vehicle 100 has an autonomous driving function, the vehicle-mounted apparatus 200 issues an instruction to the autonomous driving ECU to change the planned travel route.

The vehicle-mounted apparatus 200 and the server apparatus 500 according to the present embodiment achieve the following effects.

The vehicle-mounted apparatus 200 acquires a security reliability level management map from the server apparatus 500, and determines whether it is necessary to avoid communication with communication terminals based on the acquired security reliability level management map. The security reliability level management map includes information relating to the communication ranges of communication terminals in addition to information relating to security for the communication terminals. The information relating to security for communication terminals can be configured to include a reliability level (or “security reliability level”) relating to the security of each communication terminal. When the vehicle-mounted apparatus 200 has determined that it is necessary to avoid communication with a communication terminal, it is possible to avoid communication with that communication terminal (that is, a threat terminal) without making a significant detour by simply avoiding the communication range of that communication terminal while the vehicle 100 is travelling. By doing so, it is possible to avoid a security risk while suppressing a drop in efficiency of travel for the vehicle 100.

The vehicle-mounted apparatus 200 determines whether it is necessary to avoid communication with a communication terminal based on whether a reliability level of security for that communication terminal is equal to or below a certain level and whether the communication range of that communication terminal overlaps the planned travel route of the vehicle 100. By doing so, it is easy to determine whether it is necessary to change the planned travel route of the vehicle 100.

The vehicle-mounted apparatus 200 determines whether it is necessary to avoid communication with a communication terminal based on whether a reliability level of security for that communication terminal is equal to or below a certain level, whether the communication range of that communication terminal overlaps the planned travel route of the vehicle 100, and whether the same communication IF as the communication IF of that communication terminal is being used by the vehicle 100. By doing so, it is easy to avoid a security risk while suppressing a drop in efficiency of travel for the vehicle 100.

The server apparatus 500 determines the security reliability level of a communication terminal based on the terminal information transmitted from the communication terminal, and generates a security reliability level management map. The server apparatus 500 distributes the generated security reliability level management map to the vehicle-mounted apparatus 200. By distributing the security reliability level management map to the vehicle mounted apparatus 200, the server apparatus 500 enables the vehicle-mounted apparatus 200 to determine whether it is necessary to avoid communication with a communication terminal. By avoiding the communication range of a communication terminal in keeping with the determination result of the vehicle-mounted apparatus 200, the vehicle 100 equipped with the vehicle-mounted apparatus 200 can avoid communication with the communication terminal (that is, a threat terminal) without making a significant detour. In this way, the server apparatus 500 can enable the vehicle 100 equipped with the vehicle-mounted apparatus 200 to travel in a manner that avoids security risks while suppressing a drop in the efficiency of travel.

The terminal information received by the server apparatus 500 includes location information of a communication terminal, information relating to the security countermeasures at the communication terminal (the “security countermeasure level”), information relating to any security abnormalities at the communication terminal (the “current state”), and the radio wave transmission range of the communication terminal. The server apparatus 500 determines the security reliability level of the communication terminal based on the security countermeasures at the communication terminal and information on the current state of the communication terminal. The server apparatus 500 can also set, based on the location information of the communication terminal and the radio wave transmission range of the communication terminal, a communication range that takes into account radio wave obstructions in the periphery of the communication terminal. By doing so, it is possible to improve the accuracy of determining the security reliability level of a communication terminal and the accuracy of the communication range of the communication terminal.

The server apparatus 500 generates and updates a security reliability level management map in which information relating to the security of communication terminals and information on the communication ranges of the communication terminals have been added to a map of the management area managed by the server apparatus 500. By having the server apparatus 500 distribute this security reliability level management map to the vehicle-mounted apparatus 200, the vehicle 100 equipped with the vehicle-mounted apparatus 200 can easily avoid security risks while suppressing a drop in the efficiency of travel.

The server apparatus 500 distributes the generated security reliability level management map to the vehicle-mounted apparatuses 200 located in the management area. This makes it possible to easily distribute a security reliability level management map of an area required by a vehicle-mounted apparatus 200 to that vehicle-mounted apparatus 200.

### First Modification

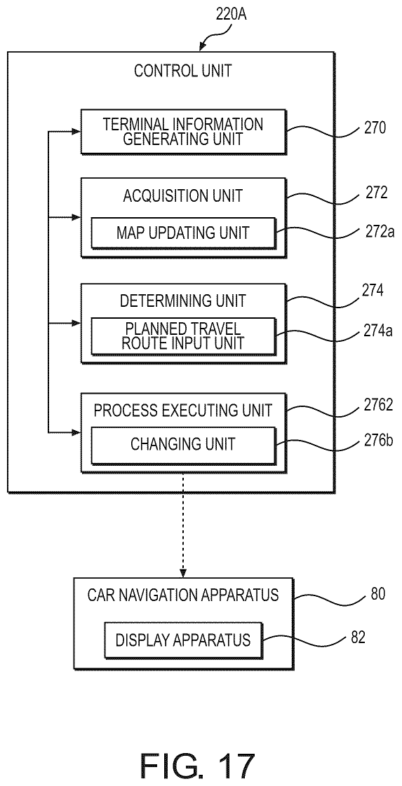

The vehicle-mounted apparatus according to this first modification includes a control unit 220A depicted in FIG. 17 in place of the control unit 220 depicted in FIG. 8. The control unit 220A includes a process executing unit 2762 as a functional unit in place of the process executing unit 276 in FIG. 8. The process executing unit 2762 includes a route proposing unit 276b as a functional unit in place of the travel route control unit 276a.

When it is necessary to avoid communication with a communication terminal (a threat terminal), the route proposing unit 276b calculates a route that bypasses the threat terminal area and suggests the bypass route to occupants (for example, the driver) of the vehicle. In more detail, the route proposing unit 276b displays the bypass route on a display apparatus 82 of a car navigation apparatus 80. When there are a plurality of detour routes, the plurality of routes may be displayed on the display apparatus 82 to enable an occupant to select a route. The first modification differs from the embodiment described above in that occupants of the vehicle are entrusted with a decision of whether to change the planned travel route. The other configurations are the same as those of the embodiment described above.

In this first modification, by using the configuration described above, the vehicle-mounted apparatus can easily avoid the communication range of a communication terminal (that is, a threat terminal) while the vehicle is traveling. This makes it possible to easily prevent the vehicle-mounted apparatus from communicating with a threat terminal without a significant detour being made.

### Second Modification

The vehicle-mounted apparatus according to the second modification causes a car navigation apparatus to execute the processing depicted in FIG. 15 (that is, calculation of routes that bypass the threat terminal area, selection of the shortest route, and a change of the planned travel route to the selected route). By doing so, the vehicle-mounted apparatus according to the second modification differs from the embodiment described above. The other configurations are the same as those of the embodiment described above.

### Third Modification

When a vehicle is traveling, a destination (that is, a planned travel route) is not always set in a car navigation apparatus. There can be cases where the vehicle is travelling without a destination set in a car navigation apparatus. In such cases, a vehicle-mounted apparatus according to the third modification predicts a planned travel route based on the current location information and driving history information. By doing so, the vehicle-mounted apparatus according to the third modification differs from the embodiment described above. When the vehicle-mounted apparatus has determined that it is necessary to change the planned travel route, the vehicle mounted apparatus may notify the occupants of the vehicle and/or may propose a route that is recommended as the planned travel route to the occupants.

### Fourth Modification

In the embodiment described above, an example is described where the vehicle-mounted apparatus acquires a planned travel route set at a car navigation apparatus. That is, in the embodiment described above, an example is described where the vehicle-mounted apparatus specifies the planned travel route of the host vehicle based on a planned travel route set in a car navigation apparatus. However, the present disclosure is not limited to the above embodiment. As one example, the vehicle-mounted apparatus may be configured to specify the planned travel route without using a car navigation apparatus. In more detail, the vehicle-mounted apparatus may specify the planned travel route by having the planned travel route inputted into the vehicle-mounted apparatus via an input IF, such as voice input or a touch panel apparatus. In addition, the vehicle-mounted apparatus may acquire a planned travel route that has been inputted into a mobile terminal (for example, a smartphone) carried by a vehicle occupant by communicating with the mobile terminal.

### Second Embodiment

The vehicle-mounted apparatus according to the present embodiment differs from the first embodiment in that it is determined whether to change the planned driving route in keeping with the security countermeasure level of the host vehicle for a case where the security reliability level of a threat terminal area is “medium”, but the planned travel route will be changed when the security reliability level of the threat terminal area is “medium” regardless of the security countermeasure level of the host vehicle. The other configurations are the same as those of the first embodiment.

In the present embodiment, if a threat terminal area with a security reliability level of “medium” is present on the planned travel route, processing that changes the planned travel route is not executed so long as the security countermeasure level of the host vehicle is equal to or above a certain level. It is assumed here that the “security countermeasure level of the host vehicle is equal to or above a certain level” means the security countermeasure level is “high”.

### Software Configuration

### Vehicle-Mounted Apparatus

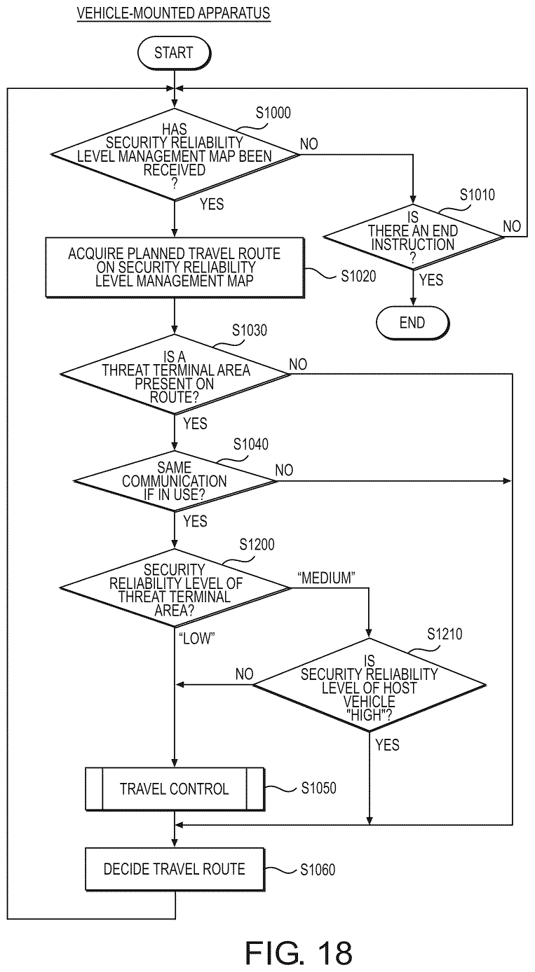

In the vehicle-mounted apparatus according to the present embodiment, the program depicted in FIG. 18 is executed in place of the program depicted in FIG. 14. The program in FIG. 18 further includes steps S1200 and S1210 in addition to the program in FIG. 14. The processing in steps S1000 to S1060 in FIG. 18 are the same as the processing in the steps depicted in FIG. 14. Parts that are different are described below.

As depicted in FIG. 18, this program includes step S1200, which is executed when it has been determined in step S1040 that the vehicle (the host vehicle) in which the vehicle-mounted apparatus is mounted is using the same communication IF (wireless IF) as a threat terminal and branches the flow of control in keeping with the security reliability level of the threat terminal in the threat terminal area, and step S1210, which is executed when it has been determined in step S1200 that the security reliability level of the threat terminal area (that is, the threat terminal itself) is “medium”, determines whether the security countermeasure level of the host vehicle is “high”, and branches the flow of control according to the result of this determination.

If it has been determined in step S1200 that the security reliability level of the threat terminal area (threat terminal) is “low,” or if it has been determined in step S1210 that the security countermeasure level of the host vehicle are not “high” (that is, the security countermeasure level is “low” or “medium”), the control proceeds to step S1050. On the other hand, if it has been determined in step S1210 that the security countermeasure level of the host vehicle is “high,” the control proceeds to step S1060.

In the present embodiment, when the security reliability level of the threat terminal area is “medium” and the security countermeasure level of the host vehicle is “high”, the vehicle will travel along the planned travel route without bypassing the threat terminal area. By doing so, the drop in the efficiency of travel is suppressed.

The other effects are the same as those of the first embodiment.

### Third Embodiment

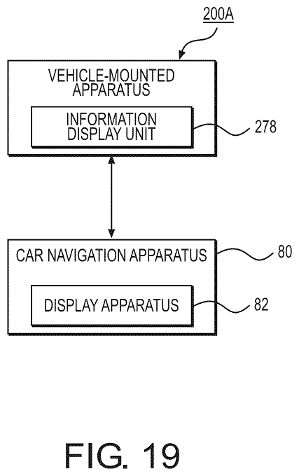

As depicted in FIG. 19, a vehicle-mounted apparatus 200A according to the present embodiment displays a security reliability level management map acquired from a server apparatus on the display apparatus 82 to present the threat terminal areas to occupants of the host vehicle as areas where avoiding travel is recommended. In the present embodiment, the vehicle-mounted apparatus 200A displays the security reliability level management map on the display apparatus 82 provided in the car navigation apparatus 80 installed inside the vehicle in which the vehicle-mounted apparatus 200A is mounted. However, the display apparatus 82 may be a display apparatus that is not part of the car navigation apparatus 80.

The vehicle-mounted apparatus 200A includes an information display unit 278 as a functional unit. The information display unit 278 controls the display apparatus 82 of the car navigation apparatus 80 to cause the display apparatus 82 to display a security reliability level management map.

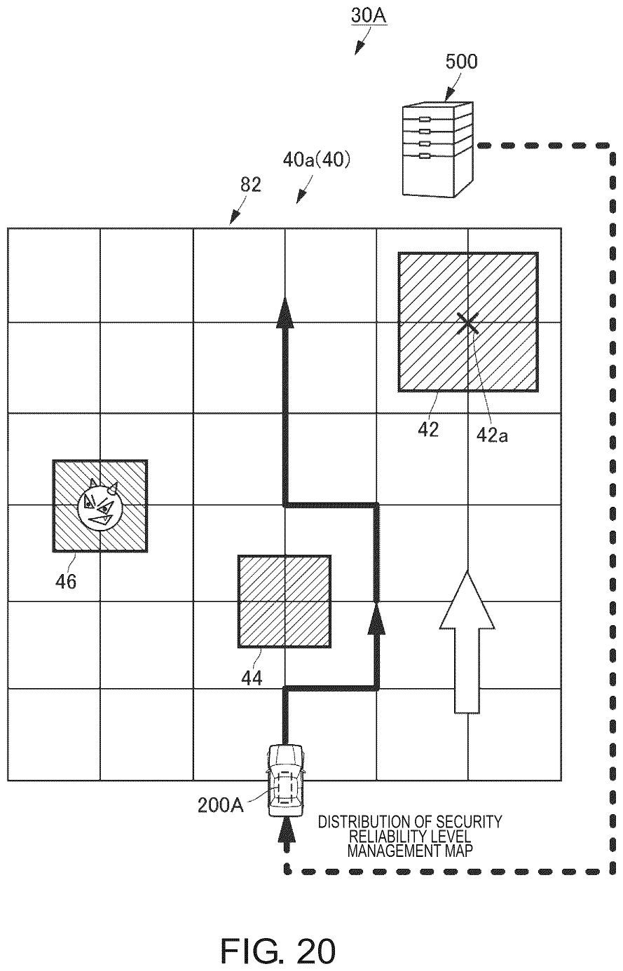

As depicted in FIG. 20, in the system 30A, when the vehicle-mounted apparatus 200A has received a security reliability level management map 40a (40) distributed from the server apparatus 500, the vehicle-mounted apparatus 200A determines whether a threat terminal area is present on the map. If a threat terminal area is present on the map, the received map is displayed on the display apparatus 82. The display format of the threat terminal areas 42, 44, and 46 may be changed in keeping with the security reliability level of the threat terminals located in each of these areas. As one example, threat terminal areas with a security reliability level of “low” and threat terminal areas with a security reliability level of “medium” may be displayed using different colors. If the security reliability level of a threat terminal is “low” and the terminal is under a security attack, the threat terminal area 46 in which such threat terminal is located may be displayed in a format that makes it possible to recognize that such terminal is under security attack. Note that the location information and communication range of a communication terminal that is not a threat terminal (for example, a communication terminal with a security reliability level of “high”) may be displayed on the map in a format that makes it possible to distinguish safe terminal areas from the threat terminal areas, for example.

The other configurations of the third embodiment are the same as those of the first embodiment.

### Software Configuration

### Vehicle-Mounted Apparatus 200A

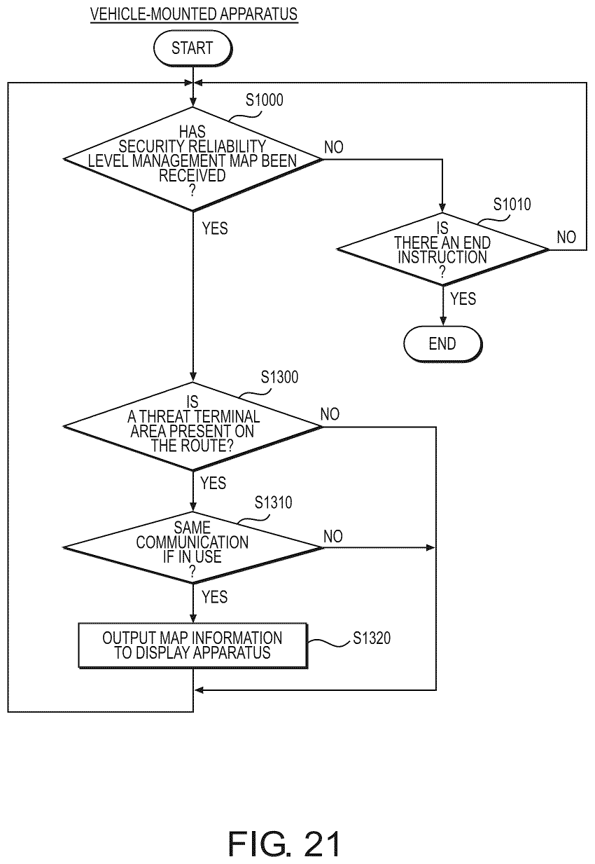

In the vehicle-mounted apparatus 200A according to the present embodiment, the program depicted in FIG. 21 is executed in place of the program depicted in FIG. 14. The program in FIG. 21 includes steps S1300, S1310, and S1320 in place of steps S1020, S1030, S1040, S1050, and S1060 in the program in FIG. 14. The processing in steps S1000 and S1010 in FIG. 21 is the same as the processing in the steps in FIG. 14. The differences between the programs are described below.

As depicted in FIG. 21, the program includes step S1300, which is executed when it has been determined in step S1000 that a security reliability level management map has been received, determines whether a threat terminal area is present on the received map, and branches the flow of control according to the determination result, step S1310, which is executed when it has been determined in step S1300 that a threat terminal area is present on the received map, determines whether the vehicle (that is, the host vehicle) in which the vehicle-mounted apparatus 200A is mounted is using the same communication IF (wireless IF) as the threat terminal located in that threat terminal area, and branches the flow of control according to the determination result, and step S1320, which is executed when it has been determined in step S1310 that the host vehicle is using the same communication IF as the threat terminal and displays map information based on the security reliability level management map on the display apparatus 82.

If it has been determined in step S1300 that there is no threat terminal area on the map, if it has been determined in step S1310 that the vehicle is not using the same communication IF as a threat terminal, or if the processing of step S1320 has been completed, the control returns to step S1000.

Note that by omitting the processing in step S1310, the map information may be displayed on the display apparatus 82 regardless of whether the host vehicle is using the same communication IF as the threat terminal.

When the vehicle-mounted apparatus 200A according to the present embodiment has received a security reliability level management map from the server apparatus 500, the vehicle-mounted apparatus 200A displays map information, which is based on the received security reliability level management map and indicates threat terminal areas, on the display apparatus 82 that is installed inside the vehicle. By doing so, it is possible to present areas where travel should preferably be avoided to the occupants (the driver) of the vehicle. This makes it easy to avoid communication with communication terminals whose security reliability level is low.

The other effects are the same as those of the first embodiment described above.

### Fourth Embodiment

The vehicle-mounted apparatus according to the present embodiment differs from the first embodiment in that when it has been determined that the host vehicle is using the same communication IF as a threat terminal, the vehicle-mounted apparatus determines whether the communication IF can be changed (switched), and in keeping with the determination result, changes the communication IF of the host vehicle to a communication IF that differs from that of the threat terminal. The other configurations are the same as those of the first embodiment.

### Functional Configuration

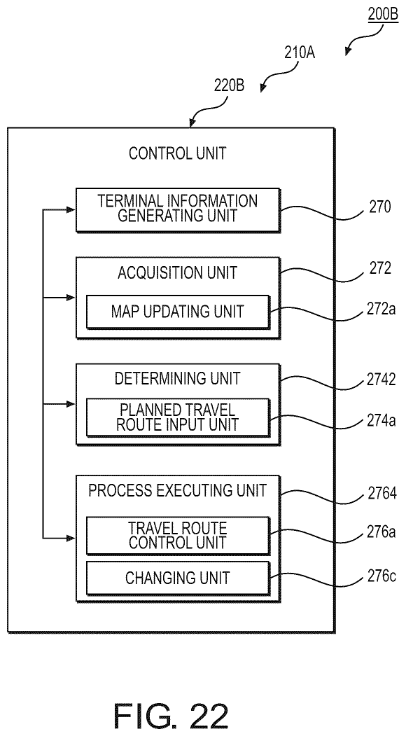

As depicted in FIG. 22, a vehicle-mounted apparatus 200B according to the present embodiment includes a GW apparatus 210A. The GW security countermeasure level 210A includes a control unit 220B in place of the control unit 220 depicted in FIG. 8. The control unit 220B includes a determining unit 2742 in place of the determining unit 274 (see FIG. 8). The control unit 220B further includes a process executing unit 2764 in place of the process executing unit 276 (see FIG. 8).

In the same way as in the first embodiment, the determining unit 2742 determines whether it is necessary to change the planned travel route based on a security reliability level management map. The determining unit 2742 also determines whether the communication IF (wireless IF) in use at the host vehicle can be changed (switched). As one example, when external communication by the communication IF (wireless IF) currently in use can be stopped, such as by temporarily stopping the service currently in use, the determining unit 2742 determines that the communication IF (wireless IF) can be changed (switched). The process executing unit 2764 further includes a changing unit 276c. In keeping with the determination result of the determining unit 2742, the changing unit 276c changes (switches) the communication IF (wireless IF) to a communication IF (wireless IF) that differs from the communication IF (wireless IF) in use by a threat terminal.

### Software Configuration

### Vehicle-Mounted Apparatus 200B

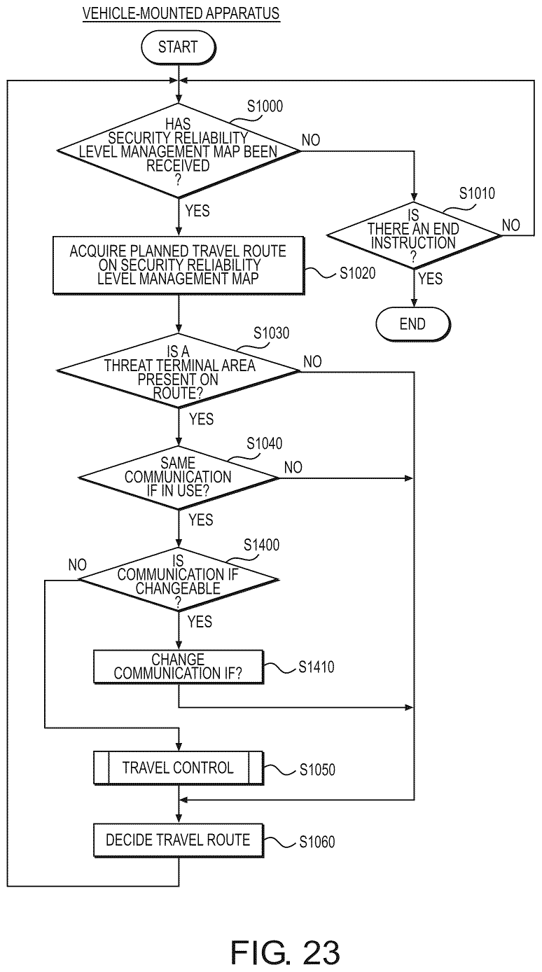

In the vehicle-mounted apparatus 200B according to the present embodiment, the program depicted in FIG. 23 is executed in place of the program depicted in FIG. 14. The program in FIG. 23 includes steps S1400 and S1410 in addition to the program in FIG. 14. The processing in steps S1000 to S1060 in FIG. 23 is the same as the processing in the steps depicted in FIG. 14. The differences between the programs are described below.

As depicted in FIG. 23, this program includes step S1400, which is executed when it has been determined in step S1040 that the vehicle (the host vehicle) in which the vehicle-mounted apparatus 200B is mounted is using the same communication IF (wireless IF) as the threat terminal, determines whether the communication IF (wireless IF) can be changed, and branches the control flow depending on the determination result, and step S1410, which is executed when it has been determined in step S1400 that the communication IF (wireless IF) can be changed and changes the communication IF (wireless IF) of the host vehicle to a different communication IF (wireless IF) to the threat terminal.

If it has been determined in step S1400 that the communication IF cannot be changed, the control proceeds to step S1050. When the processing of step S1410 ends, the control proceeds to step S1060.

In keeping with the determination result of the determining unit 2742, the vehicle-mounted apparatus 200B (the changing unit 276c) according to the present embodiment changes the communication IF of the host vehicle to a different communication IF from the communication IF of the communication terminal (the threat terminal). By doing so, it is possible to easily avoid communication with a communication terminal with a low security reliability level (that is, a threat terminal). It is also possible to avoid having to bypass a threat terminal area.

The other effects are the same as those of the first embodiment described above.

Note that instead of determining whether the communication IF in use at the host vehicle can be changed (switched), the vehicle-mounted apparatus may be configured to determine whether the communication IF in use at the host vehicle can be stopped (as one example, a temporary stoppage). In this case, the vehicle-mounted apparatus will stop the communication IF currently in use in keeping with the determination result. This also makes it easy to avoid communication with a communication terminal whose security reliability level is low (that is, a threat terminal).

### Modifications

Although examples where the vehicle-mounted apparatus includes a GW apparatus have been described in the embodiments given above, the present disclosure is not limited to these embodiments. As examples, aside from a GW apparatus, the vehicle-mounted apparatus may be an external wireless communication apparatus or an ECU (e.g., a special-purpose ECU). A vehicle-mounted apparatus may be configured by appropriately combining a GW apparatus, an external wireless communication apparatus, a special-purpose ECU, and the like.

In the embodiments given above, examples are described where the server apparatus distributes a security reliability level management map, which is security reliability level information in map format, to vehicle-mounted apparatuses. However, the present disclosure is not limited to such embodiments. The security reliability level information distributed by the server apparatus to the vehicle-mounted apparatuses does not need to be in map format. As one example, the server apparatus may distribute security reliability level information in table format to the vehicle-mounted apparatuses.

Although examples where the security countermeasure level of a communication terminal and information on the current state are calculated at that communication terminal have been given in the embodiments described above, the present disclosure is not limited to such embodiments. The security countermeasure level of a communication terminal may be calculated at a server apparatus. As one example, the communication terminal may transmit information such as whether the communication terminal has a monitoring function and whether the communication terminal performs encryption to the server apparatus, and the server apparatus may determine the security countermeasure level of the communication terminal based on such information. In the same way, the current state of the communication terminal may be calculated at the server apparatus. As one example, the communication terminal may transmit information on whether there is a security attack and whether there is an operational abnormality to the server apparatus, and the server apparatus may determine the current state of the communication terminal based on such information.

Although examples where the security reliability level of a communication terminal is divided into three levels, namely, “high”, “medium”, and “low”, are described in the embodiments given above, the present disclosure is not limited to such embodiments. The security reliability level may be classified into two levels, or four or more levels. The security reliability level may be also indicated by a numerical value or the like without being quantized. The security countermeasure level of a communication terminal and the current state of the communication terminal may also be configured in the same way as the security reliability level.

Although examples where routes that bypass threat terminal areas are calculated and the shortest route is selected from the obtained bypass routes have been described in the embodiments given above, the present disclosure is not limited to such embodiments. The criterion for selecting a route may be a criterion aside from distance. As one example, a route that bypasses a threat terminal area may be selected by taking into account the level of traffic.

In the embodiments described above, the information relating to the security of the communication terminal may be configured to include information that can be used to determine whether it is necessary to avoid communication with that communication terminal from the perspective of security during communication. As one example, the information relating to the security of the communication terminal may be configured to include information relating to security countermeasures in place of a security reliability level, or may be configured to include information relating to security attacks.

Note that each process (each function) in the embodiments described above may be realized by a processing circuit or “circuitry” including one or a plurality of processors. The processing circuit mentioned above may be configured by an integrated circuit or the like in which one or a plurality of memories, various analog circuits, and various digital circuits are combined in addition to the one or plurality of processors described above. The one or plurality of memories store programs (instructions) for causing the one or plurality of processors to execute the processes described above. The one or plurality of processors may execute the processes described above according to the program that has been read from the one or plurality of memories, or may execute the processes according to logic circuits designed in advance to execute the processes. The processors referred to here may be any of a variety of processors that are suited to computer control, such as a CPU, a GPU, a DSP (Digital Signal Processor), an FPGA (Field Programmable Gate Array), or an ASIC (Application Specific Integrated Circuit). Note that a plurality of physically separated processors may cooperate with each other to execute the above processes. As one example, processors installed in each of a plurality of physically separated computers may cooperate with each other via a network such as a LAN (Local Area Network), a WAN (Wide Area Network), or the Internet to execute the above processes.

Other embodiments that are produced by appropriately combining the techniques disclosed in the embodiments described above are also included within the technical scope of the present disclosure.

The embodiments disclosed above are exemplary in all respects and should not be regarded as limitations on the present disclosure. The scope of the present disclosure is indicated by the range of the patent claims to be taken in consideration of the detailed description of the disclosure given above, and is intended to include all changes within the meaning and scope of the patent claims and their equivalents.

1. A vehicle-mounted apparatus configured to be mounted in a vehicle, the vehicle-mounted apparatus comprising:
a processor that is configured to:
acquire security reliability level information from an external apparatus, the security reliability level information including information relating to security of a communication terminal located outside the vehicle and information relating to a communication range of the communication terminal;
determine whether it is necessary to avoid communication with the communication terminal based on the security reliability level information acquired; and
execute predetermined processing using a determination result of whether it is necessary to avoid communication with the communication terminal.

2. The vehicle-mounted apparatus according to claim 1,
wherein the processor is configured to propose, in keeping with the determination result, a travel route that avoids the communication range of the communication terminal to an occupant of the vehicle.

3. The vehicle-mounted apparatus according to claim 1,
wherein the processor is configured to change, in keeping with the determination result, a planned travel route of the vehicle to a travel route that avoids the communication range of the communication terminal.

4. The vehicle-mounted apparatus according to claim 1,
wherein the processor is configured to determine whether it is necessary to avoid communication with the communication terminal based on whether a reliability level relating to security of the communication terminal is equal to or lower than a certain level and whether the communication range of the communication terminal overlaps a planned driving route of the vehicle.

5. The vehicle-mounted apparatus according to claim 1, wherein:
the security reliability level information further includes information relating to a communication interface of the communication terminal, and
the processor is configured to change, in keeping with the determination result, a first communication interface of the vehicle to a second communication interface that differs from the communication interface of the communication terminal.

6. The vehicle-mounted apparatus according to claim 1, wherein:
the security reliability level information further includes information relating to a communication interface of the communication terminal, and
the processor is configured to determine whether it is necessary to avoid communication with the communication terminal based on whether a reliability level relating to security of the communication terminal is equal to or lower than a certain level, whether the communication range of the communication terminal overlaps a planned travel route of the vehicle, and whether a communication interface that is the same as the communication interface of the communication terminal is being used at the vehicle.

7. The vehicle-mounted apparatus according to claim 1,
wherein the processor is configured to display, based on the security reliability level information, map information, in which areas where avoidance of travel is recommended are indicated, on a display installed inside the vehicle.

8. A server apparatus comprising:
a receiver that is configured to receive predetermined terminal information transmitted from an external communication terminal; and
a processor that is configured to:
determine a security reliability level of the communication terminal based on the terminal information received by the receiver;
generate security reliability level information including information relating to security of the communication terminal, which includes a determination result of the security reliability level of the communication terminal, and information which relates to a communication range of the communication terminal and is based on the terminal information; and
distribute the security reliability level information generated to a vehicle-mounted apparatus.

9. The server apparatus according to claim 8, wherein:
the terminal information received by the receiver includes location information of the communication terminal, information relating to security countermeasures at the communication terminal, information relating to security abnormalities at the communication terminal, and a radio wave transmission range of the communication terminal,
the processor is configured to determine the security reliability level of the communication terminal based on the information relating to security countermeasures at the communication terminal and the information relating to security abnormalities at the communication terminal, and
the processor is configured to set the communication range taking into consideration radio wave obstructions in a periphery of the communication terminal based on the location information of the communication terminal and the radio wave transmission range of the communication terminal.

10. The server apparatus according to claim 8, wherein:
the security reliability level information includes a security reliability level management map in which information relating to security of the communication terminal and information relating to the communication range of the communication terminal are added to a map of a management area managed by the server apparatus, and
the processor is configured to generate the security reliability level management map based on the information relating to the security of the communication terminal and the terminal information.

11. The server apparatus according to claim 10,
wherein the processor is configured to distribute the security reliability level management map generated to a vehicle-mounted apparatus located in the management area.

12. A storage medium that stores a computer program that causes a processor mounted in a vehicle perform the following:
acquire security reliability level information from an external apparatus, the security reliability level information including information relating to security of a communication terminal located outside the vehicle and information relating to a communication range of the communication terminal;
determine whether it is necessary to avoid communication with the communication terminal based on the security reliability level information acquired; and
execute predetermined processing using a determination result of whether it is necessary to avoid communication with the communication terminal.

13. A security risk avoidance method for a vehicle-mounted apparatus mounted in a vehicle, the method comprising:
acquiring security reliability level information from an external apparatus, the security reliability level information including information relating to security of a communication terminal located outside the vehicle and information relating to a communication range of the communication terminal;
determining whether it is necessary to avoid communication with the communication terminal based on the security reliability level information acquired; and
executing predetermined processing using a determination result of whether it is necessary to avoid communication with the communication terminal.
